(19) United States
(12) Patent Application Publication
(10) Pub. No.: US 2004/0252186 A1
(43) Pub. Date: Dec. 16, 2004

(54) Method, program, storage medium, server and image filter for displaying a three-dimensional image

(76) Inventors: Ken Mashitani, Osaka (JP); Goro Hamagishi, Osaka (JP); Kenji Torasawa, Oogaki-shi (JP)

Correspondence Address: MCDERMOTT, WILL & EMERY, 600 13th Street, N.W., Washington, DC, 20005-3096, US

(21) Appl. No.: 10/804,199

(22) Filed: Mar. 19, 2004

(30) Foreign Application Priority Data
Mar. 20, 2003 (JP) JP2003-079214

(51) Int. Cl. H04N 15/00

(52) U.S. Cl. 348/51; 348/42; 380/200

(57) ABSTRACT

A business model is provided which enables proactive development of 3D stereoscopic image data distribution services, while preventing the providing servers' interests from being hurt by unauthorized copying. A user terminal sends a disk ID, which has been encrypted and pre-stored in a distributed media, to a service providing device via the Internet. The service providing device sends a cryptographic key to decrypt said encrypted disk ID to the user terminal via the Internet. The user terminal decrypts the encrypted disk ID by the received cryptographic key, and once the cryptographic key is determined valid a 3D stereoscopic image display function of 3D software is enabled and the 3D stereoscopic image data stored in the distributed media is displayed as a 3D stereoscopic image.

### BACKGROUND OF THE INVENTION

1. Field of the Invention

The present invention relates to an image reproduction system and a program thereof for reproducing an image content, and it is particularly suitable for stereoscopically viewing distributed image data.

2. Description of the Related Art

Along with the popularization of the Internet, the services to distribute various types of data are being commercialized. Especially, businesses to distribute music data and image data such as movies and photographs are actively being promoted. Today, image data are distributed and reproduced as a 2D image, like an ordinary TV image. However, in the future, distribution of image data, which can be reproduced as a 3D stereoscopic image, is expected. Distribution of 3D stereoscopic image data will be capable of responding to the needs of users who desire more realistic image reproduction.

The inventors have previously proposed the invention of a system to realize a service to distribute 3D stereoscopic image data as described in the reference [1] below. In this invention by sending an identification number, which has been given to the optical filter for stereoscopic viewing, to an image data providing server, image data, which can be viewed stereoscopically through this optical filter, are sent from the providing server to the user terminal.

However, according to the invention mentioned above, it is possible to reproduce acquired image data as a 3D stereoscopic image on another terminal device with an identical type optical filter. Therefore, it is feared that through unauthorized copying of the acquired image data by malicious users, the distributors' interests may be damaged.

Further, in the invention mentioned above, 3D stereoscopic image data is acquired from a providing server by using an identification number given to the optical filter. Meanwhile, a type of business can also be postulated, in which a storage media is delivered with pre-stored 3D stereoscopic image data together with the optical filter, to the users. For example, it is possible to create a business model, in which sample image data and billable 3D stereoscopic image data are stored in the storage media and reproduction of billable 3D stereoscopic image data becomes possible by obtaining key data. However, this type of business model cannot be realized by the invention mentioned above. To stimulate the interest of the users and drive the users to buy 3D stereoscopic image data, trial reproduction of a sample image is effective, however on this point, the invention mentioned above is inadequate.

Related art list:

[1] JP 2003-102036 A

### SUMMARY OF THE INVENTION

The present invention has been made based on these considerations, and an object thereof is to offer an image content reproduction system and its program, which enables proactive development of 3D stereoscopic image data distribution services, while preventing the providing servers' interests from being damaged by unauthorized copying.

According to one aspect of the present invention, a program for providing a computer with a function for displaying a three-dimensional stereoscopic image is provided. The program comprises reproducing a three-dimensional stereoscopic image content as a three-dimensional stereoscopic image; reproducing the content with a restriction; determining whether the content can be reproduced as a three-dimensional stereoscopic image; and switching a reproduction process according to a result of the determining.

The reproducing the content with a restriction may perform a process for reproducing the content as a two-dimensional image.

The reproducing the content with a restriction may perform a process for reproducing a part of the content as a three-dimensional stereoscopic image.

The reproducing the content with a restriction may perform a process for reproducing the content on which another image is superimposed.

The program may further comprise obtaining a key for reproducing the content as a three-dimensional stereoscopic image by accessing a server which offers the content.

The obtaining the key may be performed when it is determined that the content cannot be reproduced as a three-dimensional stereoscopic image.

The content may be totally or partially encoded by the key, and the reproducing the content as a three-dimensional stereoscopic image may include decoding the content by using the key.

A program module for reproducing the content as a three-dimensional stereoscopic image may be encoded by the key, and the switching the reproduction process may include decoding the program module by using the key.

The program may comprise an encoded identification code therein, and it may be determined whether the content can be reproduced as a three-dimensional stereoscopic image, by decoding the encoded identification code by using the key.

The program may comprise an unencoded identification code as well as the encoded identification code therein, and it may be determined whether the content can be reproduced as a three-dimensional stereoscopic image, by decoding the encoded identification code by using the key and comparing the decoded identification code with the unencoded identification code.

The program may further comprise obtaining an encoded identification code from a three-dimensional stereoscopic image filter for viewing the content stereoscopically, and it may be determined whether the content can be reproduced as a three-dimensional stereoscopic image, by decoding the encoded identification code by using the key.

The program may comprise obtaining an unencoded identification code as well as the encoded identification code, and it may be determined whether the content can be reproduced as a three-dimensional stereoscopic image, by decoding the encoded identification code by using the key and comparing the decoded identification code with the unencoded identification code.

According to another aspect of the present invention, a storage medium storing a program for providing a computer with a function for displaying a three-dimensional stereoscopic image, the program is provided. The storage medium comprises reproducing a three-dimensional stereoscopic image content as a three-dimensional stereoscopic image; reproducing the content with a restriction; determining whether the content can be reproduced as a three-dimensional stereoscopic image; and switching a reproduction process according to a result of the determining.

According to still another aspect of the present invention, a server is provided. The server comprises a storing unit which stores a key which corresponds to an identification code of a program, which is offered to a user, for providing a computer with a function for displaying a three-dimensional stereoscopic image; a determining unit which determines whether an access from a user terminal is valid; and a transmitting unit which transmits the key which corresponds to the program to the user terminal when the access is determined to be valid.

According to still another aspect of the present invention, a three-dimensional stereoscopic image filter for viewing a content stereoscopically is provided. The image filter comprises a storing unit which stores an encoded identification code and an unencoded identification code; and a transmitting unit which retrieves the encoded identification code and the unencoded identification code from the storing unit and transmits the identification codes to a user terminal.

Moreover, any arbitrary replacement or substitution of the above-described structural components and the steps, expressions replaced or substituted in part or whole between a method, a program, a storage medium, a server and an image filter as well as addition thereof, and expressions changed to an apparatus, a system, a data structure, a transmission medium or the like are all effective as and are encompassed by the present invention.

This summary of the invention does not necessarily describe all necessary features, so that the invention may also be a sub-combination of these described features.

### BRIEF DESCRIPTION OF THE DRAWINGS

FIG. 1 is a block diagram of a 3D stereoscopic image providing system according to an embodiment.

FIG. 2 shows a structure of a distributed media according to an embodiment.

FIG. 3 shows a structure of a 3D filter according to an embodiment.

FIG. 4 shows a block diagram of a service providing device according to an embodiment.

FIG. 5 shows a structure of an ID database according to an embodiment.

FIG. 6 shows a block diagram of a user terminal according to an embodiment.

FIG. 7 is a flowchart showing a part of a process flow of 3D software executed by a user terminal according to an embodiment.

FIG. 8 is a flowchart showing a part of a process flow of 3D software executed by a user terminal according to an embodiment.

FIG. 9 is a flowchart showing a part of a process flow of 3D software executed by a user terminal according to an embodiment.

FIG. 10A is a flowchart showing an advanced processing, and FIG. 10B is a flowchart showing a basic processing according to an embodiment.

FIG. 11A is a flowchart showing an advanced processing, and FIG. 11B is a flowchart showing a basic processing according to another embodiment.

FIG. 12A is a flowchart showing an advanced processing, and FIG. 12B is a flowchart showing a basic processing according to yet another embodiment.

FIG. 13A is a flowchart showing an advanced processing, and FIG. 13B is a flowchart showing a basic processing according to yet another embodiment.

FIG. 14A is a flowchart showing an advanced processing, and FIG. 14B is a flowchart showing a basic processing according to yet another embodiment.

FIG. 15A is a flowchart showing an advanced processing, and FIG. 15B is a flowchart showing a basic processing according to yet another embodiment.

FIG. 16A is a flowchart showing an advanced processing, and FIG. 16B is a flowchart showing a basic processing according to yet another embodiment.

FIG. 17A is a flowchart showing an advanced processing, and FIG. 17B is a flowchart showing a basic processing according to yet another embodiment.

FIG. 18 shows an object and four viewpoints from which the object is viewed according to an embodiment.

FIG. 19 shows a structure of 3D stereoscopic image data containing image data corresponding to four viewpoints according to an embodiment.

FIG. 20 shows another structure of 3D stereoscopic image data containing image data corresponding to four viewpoints according to an embodiment.

FIGS. 21A to 21C show image data corresponding to four viewpoints and logo image data according to an embodiment.

FIG. 22 shows a range where a stereoscopic image is observed and a range where a logo image is observed according to an embodiment.

FIG. 23 shows an object and viewpoints surrounding the object according to an embodiment.

FIG. 24 shows a structure of 3D stereoscopic image data containing image data corresponding to 12 viewpoints according to an embodiment.

FIG. 25 shows a structure of 3D stereoscopic image data containing 3D model data according to an embodiment.

FIG. 26 shows a structure of 3D stereoscopic image data containing image data corresponding to one viewpoint and a depth map according to an embodiment.

FIG. 27 shows another structure of a 3D filter according to an embodiment.

### DETAILED DESCRIPTION OF THE INVENTION

The invention will now be described by reference to the preferred embodiments. This does not intend to limit the scope of the present invention, but to exemplify the invention.

1. Environment Block Diagram

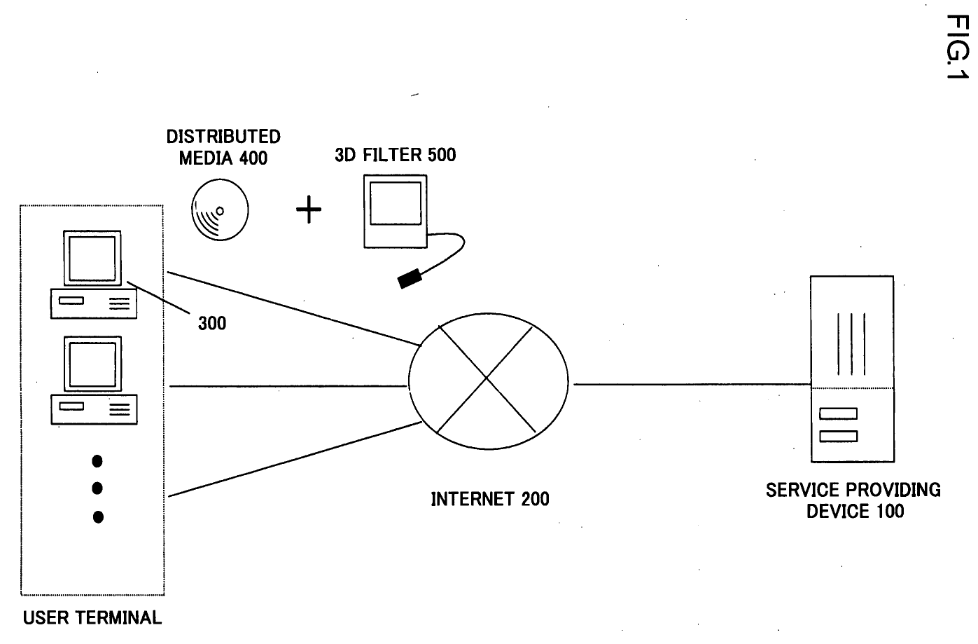

FIG. 1 is a block diagram of a 3D stereoscopic image providing system, which is one of the embodiments of the present invention. Said 3D stereoscopic image providing system is configured of the service providing device 100, the Internet 200, and the user terminal 300.

When the user sets up both the distributed media 400, which has been distributed in advance, and the 3D filter 500 in the user terminal 300, and executes the 3D software stored in the distributed media 400, the user terminal 300 sends the disk ID, which has been encrypted and pre-stored in the distributed media 400, to the service providing device 100 via the Internet 200. Upon receiving said encrypted disk ID, the service providing device 100 sends a cryptographic key to decrypt said encrypted disk ID to the user terminal 300 via the Internet 200.

The user terminal 300 executes the 3D software and decrypts the disk ID, which has been encrypted, with the received cryptographic key to verify the validity of the cryptographic key. Once the cryptographic key is determined to be valid, the 3D stereoscopic image display function of the 3D software is enabled by using said cryptographic key and the 3D stereoscopic image data stored in the distributed media 400 are displayed as a 3D stereoscopic image on the display apparatus of the user terminal 300. This will enable the user to view said 3D stereoscopic image.

2. Distributed Media

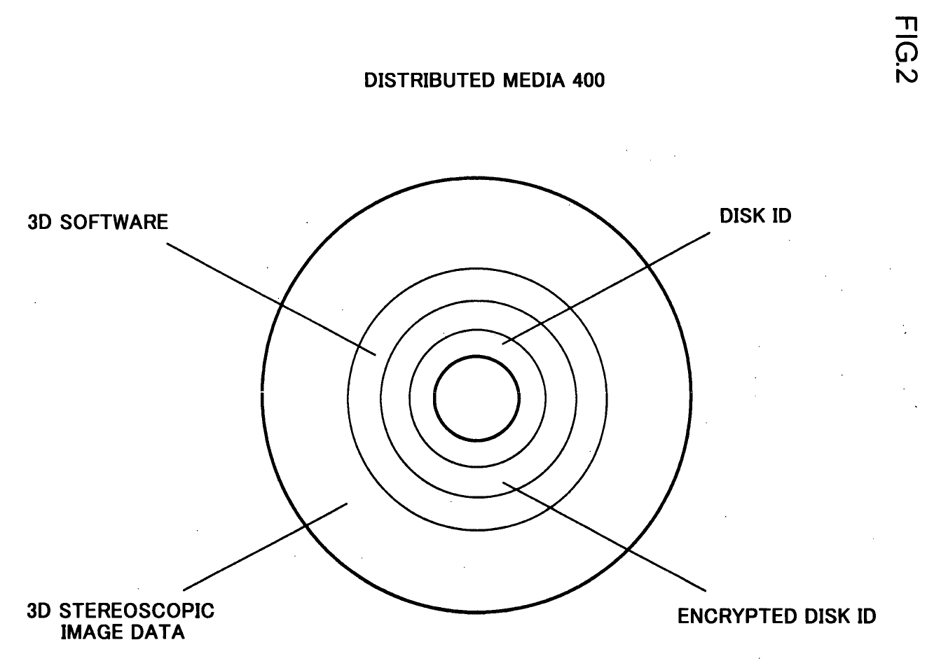

The distributed media 400 is distributed in advance to the users by the 3D stereoscopic image providers together with the 3D filter 500. With reference to FIG. 2, in the distributed media 400, the disk ID to verify the validity of the disk, the disk ID which has been encrypted, (hereinafter referred to as “Encrypted Disk ID”), the 3D software which is necessary when the users view a 3D stereoscopic image, and the 3D stereoscopic image data are stored.

Further, the 3D software has such functions as the communications function which enables the user terminal 300 to access the service providing device 100 via the Internet 200, and the function to display 3D stereoscopic image data as a 3D stereoscopic image.

3. 3D filter

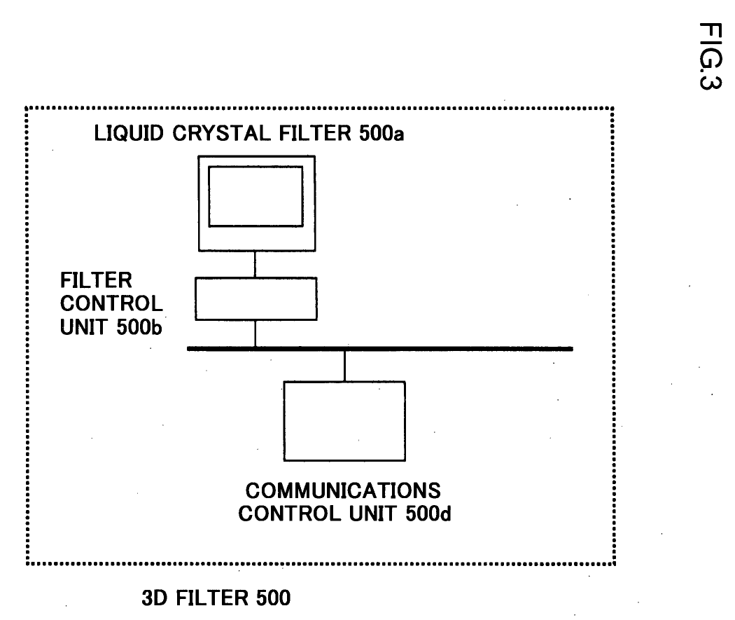

With reference to FIG. 3, the 3D filter 500 is configured of the liquid crystal filter 500a, which forms a stereoscopic filter to enable the users to stereoscopically view a 3D stereoscopic image displayed on the user terminal 300; the filter control unit 500b, which controls formation of the stereoscopic filter; and the communications control unit 500d, which makes a connection with the user terminal via USB and such.

When the 3D filter 500 is switched to ON by the user terminal 300 via USB and such, the filter control unit 500d adjusts the liquid crystal and forms a barrier with multiple slits on the 3D filter 500.

The user can stereoscopically view a 3D stereoscopic image displayed on the display apparatus 300a through this barrier with slits.

When the 3D filter 500 is switched to OFF, the barrier with multiple slits is deactivated and the 3D filter 500 becomes a mere transparent body.

As a result, even if 3D stereoscopic image data are displayed on the display apparatus 300a, the user cannot stereoscopically view the corresponding 3D stereoscopic image.

4. Service Providing Device

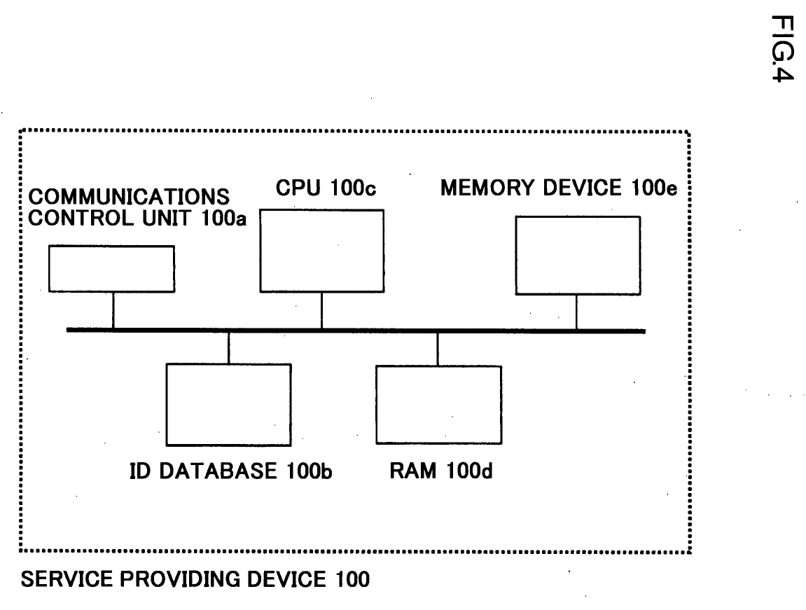

With reference to FIG. 4, the service providing device 100 is configured of the communications control unit 100a which controls communications with the user terminal via the Internet 200; the ID database 100b which stores data such as the Encrypted Disk ID of the distributed media 400 that has been distributed to the user; the CPU 100c which searches for the Encrypted Disk ID sent from the user terminal 300 on the ID database 100b and executes the program to send the cryptographic key which corresponds to said Encrypted Disk ID to the user terminal 300; the storage device 100e which stores said program; and the RAM 100d which stores the data necessary to execute said program.

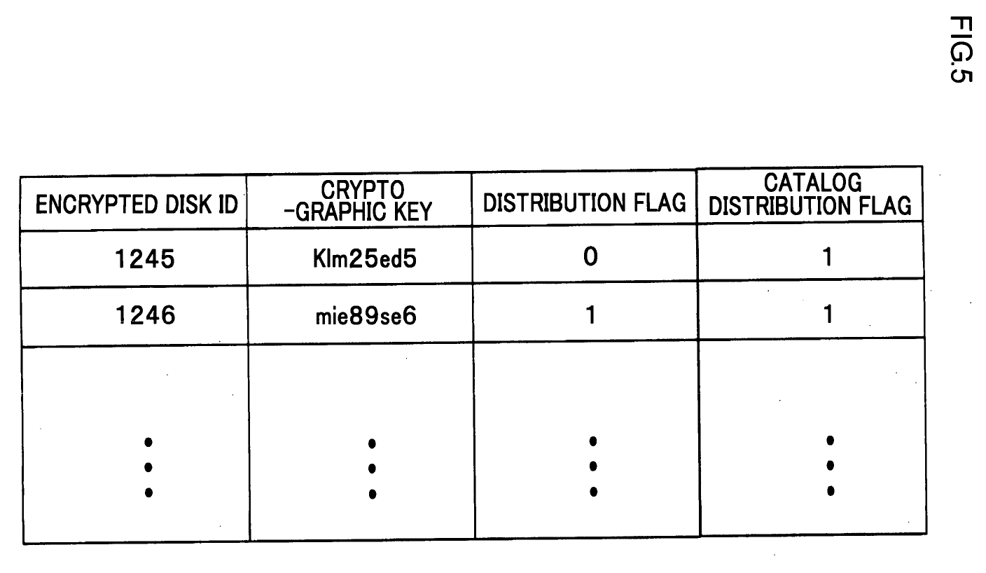

With reference to FIG. 5, in the ID database 100b, the following items, which correspond to the Encrypted Disk ID within the distributed media 400 which has been distributed to the user, are stored: the cryptographic key, a distribution flag, and data regarding whether or not catalog distribution is requested etc. The cryptographic key is necessary to display 3D stereoscopic images included in the distributed media 400 by the 3D software. In other words, by decrypting the Encrypted Disk ID stored in the distributed media 400 by this cryptographic key, the disk ID is obtained. On the side of the user terminal 300, this disk ID is checked out against the disk ID separately stored in the distributed media 400, and when these two match 3D stereoscopic image display is enabled.

The distribution flag shows whether or not a contract regarding 3D stereoscopic image provision has been concluded between the user, who has the distributed media 400 in which said Encrypted Disk ID is stored, and a 3D stereoscopic image provider. The distribution flag is set to “1” when a contract has been concluded, and to “0” when a contract has not been concluded. The catalog distribution flag shows whether or not catalog distribution has been requested by the user who has said distributed media. The catalog distribution flag is set to “1” when the user has requested a catalog distribution, and to “0” when the user has not requested catalog distribution.

For example, in FIG. 5, the cryptographic key to decrypt the Encrypted Disk ID “1245” is “klm25ed5” and the distribution flag is 0, which means that this user has not concluded a contract regarding 3D stereoscopic image provision. In addition, the catalog distribution flag is 1, which means that this user has requested catalog distribution.

5. User Terminal

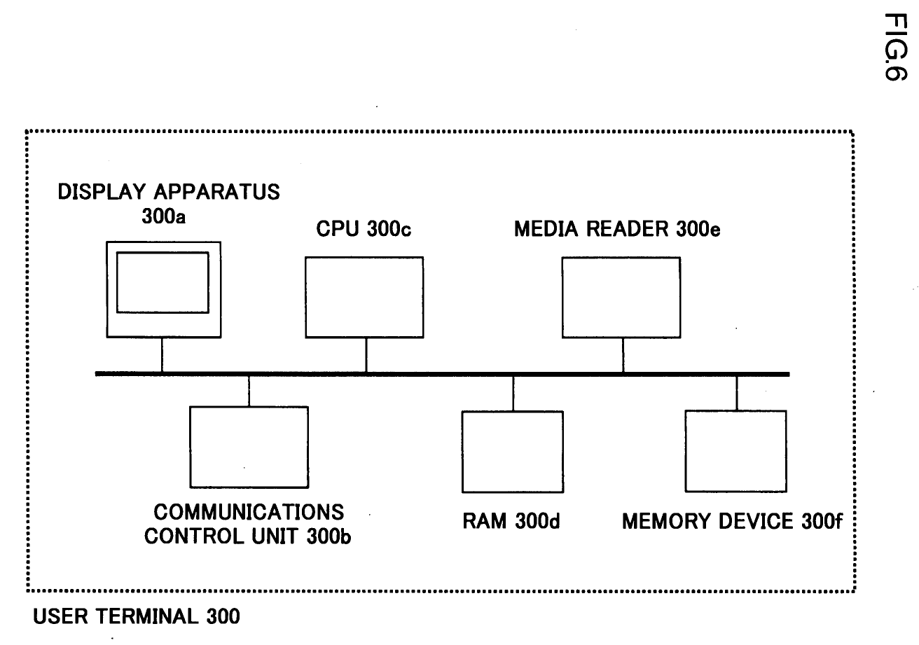

With reference to FIG. 6, the user terminal 300 is configured of the display apparatus 300a which displays image data; the communications control unit 300b which establishes communication with the service providing device 100 via the Internet 200; the CPU 300c which executes the 3D software included in the distributed media 400; the RAM 300d which stores data necessary to execute the 3D software; the media reader 300e which controls access with the distributed media 400; and the storage device 300f which stores the 3D software program and cryptographic key sent from the service providing device 100.

In the following, the process flow will be described, in which when the user sets up the distributed media 400 in the media reader 300e and executes the 3D software within the distributed media 400 from the user terminal 300, said software is executed by the CPU 300c.

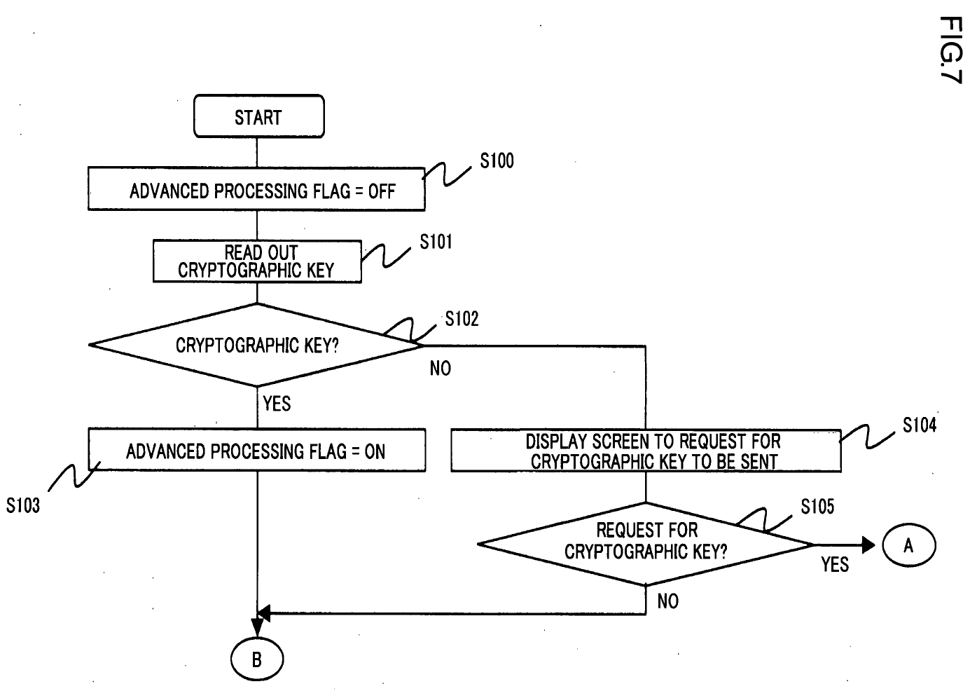

FIGS. 7 through 9 are flowcharts showing the process up to the point where the type of processing, whether advanced or basic, is determined within the process flow of the 3D software executed by the CPU 300C.

Advanced processing means that the CPU 300c displays the 3D stereoscopic image data stored in the distributed media 400 on the display apparatus 300a as a 3D stereoscopic image. When a contract regarding 3D stereoscopic image provision has been concluded between the user and the 3D stereoscopic image provider, the user terminal 300 can receive an authorized cryptographic key from the service providing device 100. In addition, through the CPU 300c enabling the advanced processing by using this cryptographic key, it is possible to display the 3D stereoscopic image data stored in the distributed media 400 as a 3D stereoscopic image.

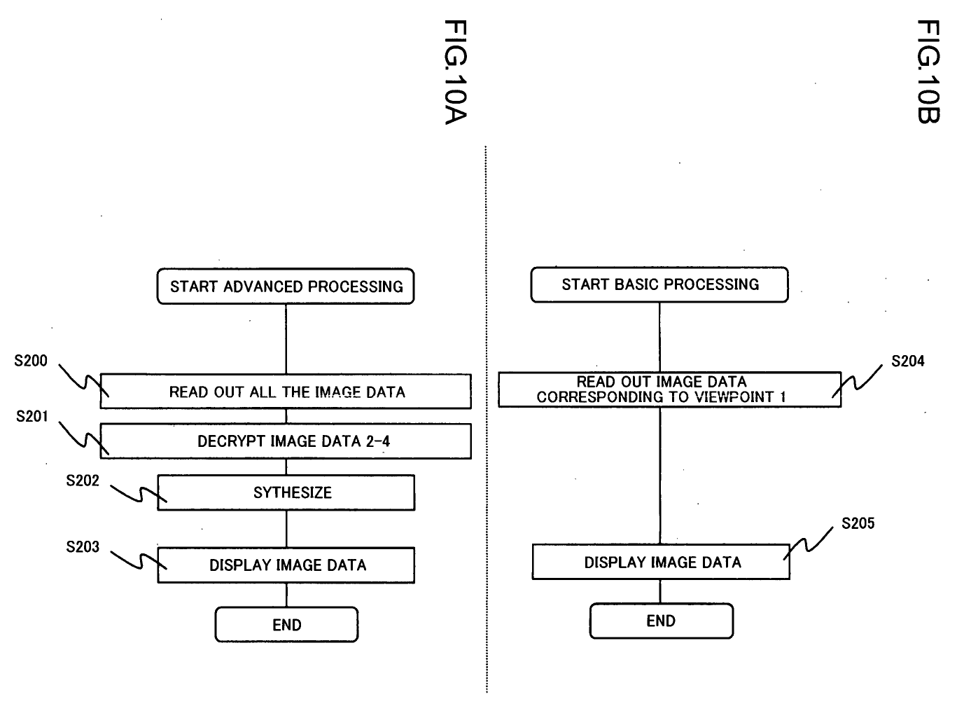

Basic processing means that the CPU 300c displays the 3D stereoscopic image data stored in the distributed media 400 with restrictions. When a contract regarding 3D stereoscopic image provision has not been concluded between the user and the 3D stereoscopic image provider, the user terminal 300 cannot receive a cryptographic key from the service providing device 100. In this case, the CPU 300c enables basic processing instead of advanced processing to display the 3D stereoscopic image data stored in the distributed media 400 as a 2D image, or display said data as a 3D stereoscopic image with restrictions. Examples of advanced processing and basic processing will be described later with reference to FIGS. 10 through 17.

6. Flow to Obtain Cryptographic Key

With reference to FIG. 7, in Step S100 the CPU 300c within the user terminal 300 turns the advanced processing flag, which as will be described in detail later is to indicate whether or not the advanced processing will be executed, to OFF.

Next, in Step S101 the cryptographic key is read out from the prescribed place in the storage device 300f. In Step S102 the validity of said cryptographic key is verified. Validity verification is done by the CPU 300c decrypting the Encrypted Disk ID stored in the distributed media 400 using said cryptographic key and checking to see whether or not it matches with the disk ID also stored in the distributed media 400.

When said cryptographic key is determined to be valid, the process proceeds to Step S103, and if determined to be invalid, the process proceeds to step S104. In the case that said cryptographic key does not exist in the prescribed place in the storage device 300f, the process also proceeds to Step S104.

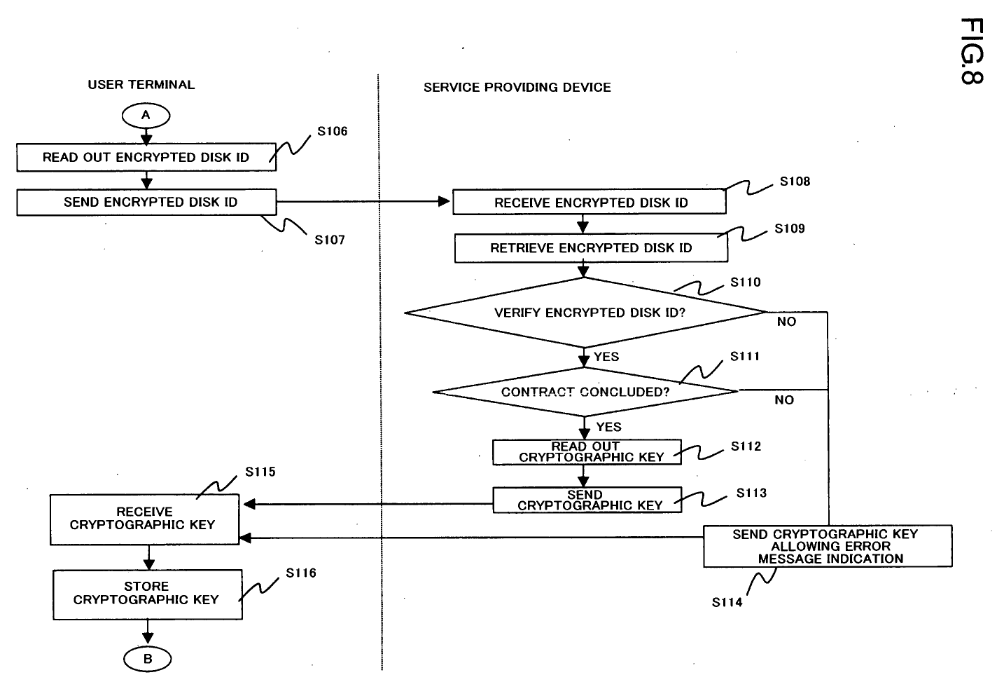

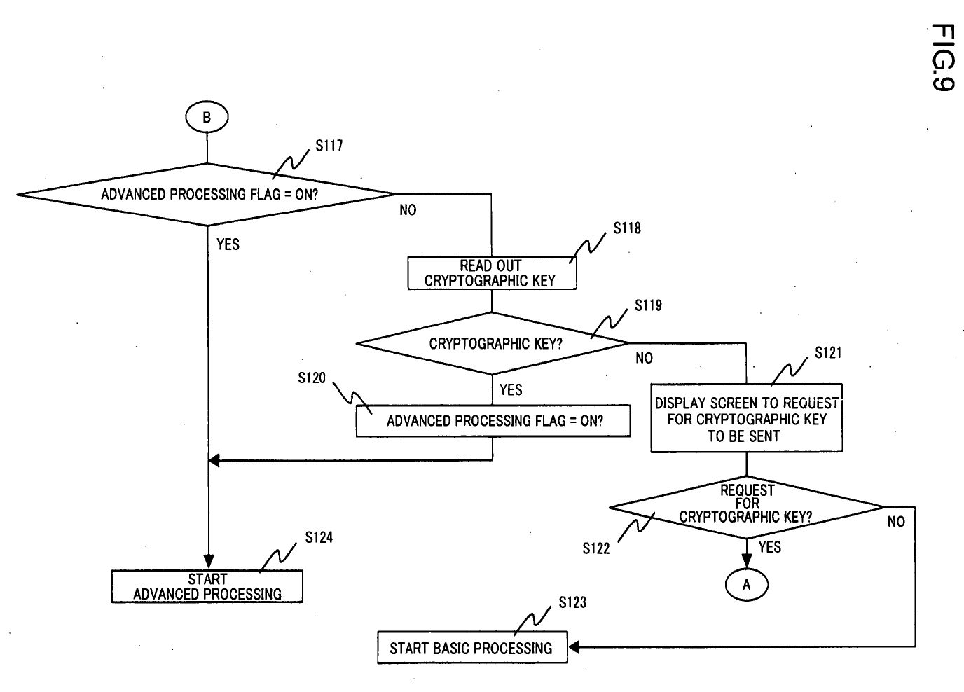

In Step S103 the advanced processing flag is turned to ON, and the process proceeds to Step S117 (FIG. 9). In Step S104 the CPU 300c displays a screen on the display apparatus 300a, which asks whether or not sending of a cryptographic key is requested. In Step S105 in the case that the user does not request sending of a cryptographic key, the process proceeds to Step S117 (FIG. 9), and in the case that the user requests sending of a cryptographic key, the process proceeds to Step S106 (FIG. 8).

With reference to FIG. 8, in Step S106 the CPU 300c reads out the Encrypted Disk ID from the distributed media 400 and sends it from the communications control unit 300b to the service providing device 100. In Step S108 the service providing device 100 receives the Encrypted Disk ID sent from the user terminal 300, and then in Step S109 the CPU 100c searches for the received Encrypted Disk ID on the ID database 100b.

Next, in Step S110, the existence or nonexistence of said Encrypted Disk ID in the ID database 100b is checked. If it exists, the process proceeds to Step S111, and if it is nonexistent, the process proceeds to Step S114.

In Step S111, within the ID database 100b the distribution flag value, either 0 or 1, which corresponds to said Encrypted Disk ID is verified. As described earlier, a distribution flag which is 0 indicates that a contract regarding stereoscopic image provision has not been concluded between the user and a stereoscopic image provider, and a distribution flag which is 1 indicates that said contract has been concluded.

When the distribution flag is 1, the process proceeds to Step S112, and when the distribution flag is 0, the process proceeds to Step S114. In Step S112 the cryptographic key which corresponds to said Encrypted Disk ID is read out from the ID database 100b, and in Step S113 said cryptographic key is sent to the user terminal 300. In Step S114 a cryptographic key allowing predefined error messages to be shown is sent to the user terminal 300.

The user terminal 300 receives the cryptographic key sent from the service providing device in Step S115, and then in Step S116 stores the received cryptographic key in the storage device 300f to proceed to Step S117 (FIG. 9). In doing so, if a cryptographic key has already been stored in the storage device 300f it shall be deleted.

With reference to FIG. 9, in Step S117 the CPU 300c checks for ON/OFF of the advanced processing flag. If it is ON, the process proceeds to Step S124, and if it is OFF, the process proceeds to Step S118.

In Step S118 the cryptographic key is read out from the prescribed place in the storage device 300f. In Step S119 the validity of said cryptographic key is verified. Validity verification is done, as described earlier, by the CPU 300 decrypting the Encrypted Disk ID stored in the distributed media 400 using said cryptographic key and checking to see whether or not it matches with the disk ID also stored in the distributed media 400.

When said cryptographic key is verified to be valid the process proceeds to Step S120, and if not verified to be valid the process proceeds to Step S121.

In Step S120 the advanced processing flag is turned to ON, and the process proceeds to Step S124.

In Step S121 the CPU 300c displays a screen on the display apparatus 300a, which asks whether or not sending of a cryptographic key is requested. In Step S122 if the user does not request a cryptographic key to be sent the process proceeds to Step S123, and if the user requests a cryptographic key to be sent the process goes back again to Step S106.

In Step S123 basic processing is executed, and in Step S124 advanced processing is executed.

In the following, the embodiments of the advanced processing in Step S124 and basic processing in Step S123 will be described.

7. Advanced Processing flow 1

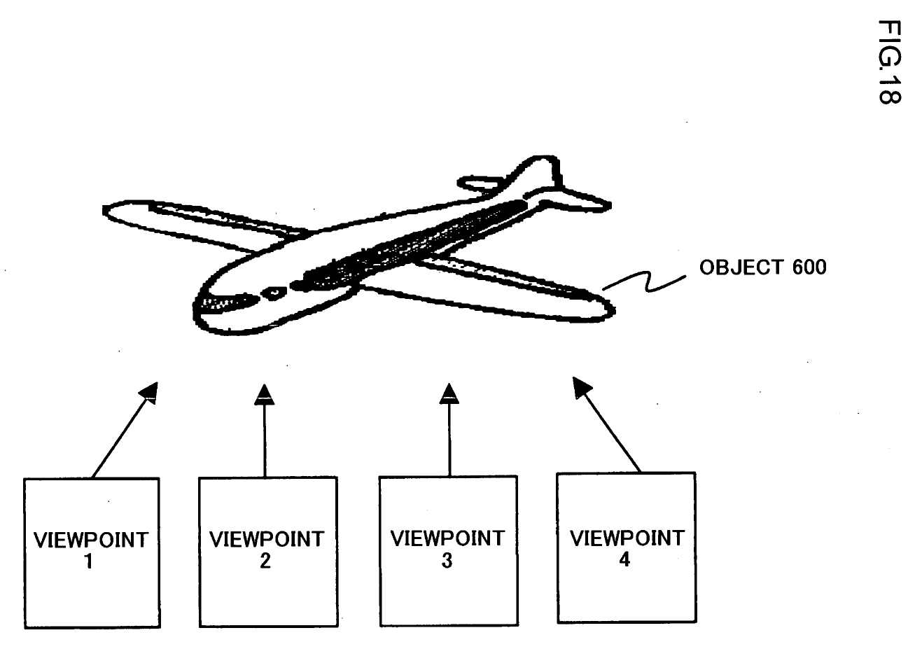

FIG. 18 shows four viewpoints: the viewpoints 1 through 4, from which the object 600 is viewed.

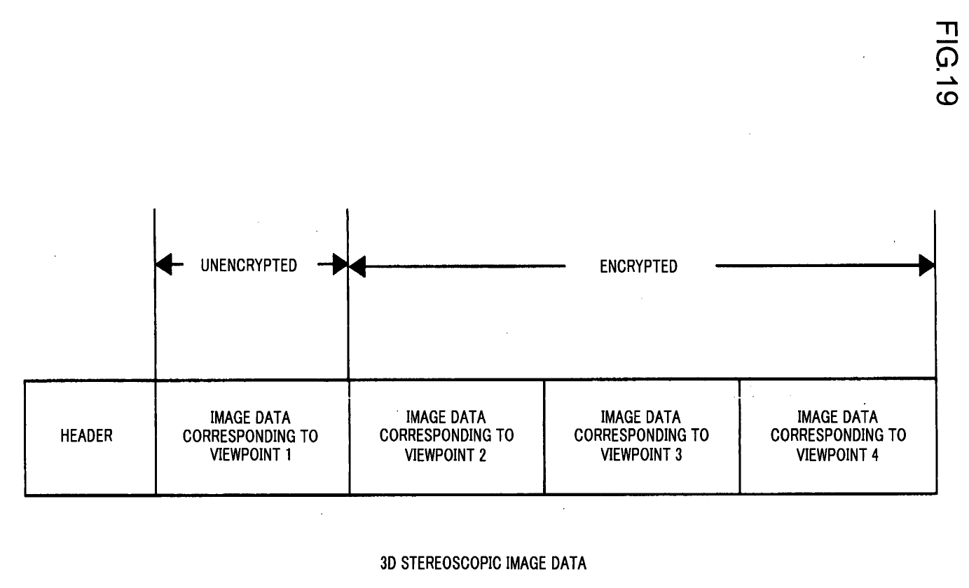

With reference to FIG. 19, as for the structure of the 3D stereoscopic image data stored in the distributed media 400, a header is located in the forefront, in which data such as the name of the 3D stereoscopic image, number of viewpoints, data format, and data size are stored. After the header, the four image data, which correspond respectively to the viewpoints 1 through 4, are stored. In FIG. 19 only the image data which corresponds to the viewpoint 1 is unencrypted, and the other image data which correspond respectively to the viewpoints 2 through 4 are encrypted by a cryptographic key.

In other words, a case is assumed in which there are four 3D stereoscopic image data stored in the distributed media 400 which correspond respectively to the four viewpoints, and out of these the three image data which correspond respectively to the viewpoints 2 through 4 are encrypted.

With reference to FIG. 10A, when the CPU 300c does an advanced processing, in Step S200 the four image data which correspond respectively to the viewpoints 1 through 4 are read out to the RAM 300d from the distributed media 400.

Next, in Step S201 the three image data which correspond respectively to the viewpoints 2 through 4 are decrypted using a cryptographic key, and in Step S202 the four image data which correspond respectively to the viewpoints 1 through 4 are synthesized to generate one 3D stereoscopic image data. In other words, the four image data, which correspond respectively to the four viewpoints, are synthesized into one piece of image data to generate a 3D stereoscopic image data which combines all the aspects of the four viewpoints.

In Step S203 the synthesized 3D stereoscopic image data is displayed on the display apparatus 300a as a 3D stereoscopic image.

With reference to FIG. 10B, when the CPU 300c does a basic processing, in Step S204 only the image data which corresponds to the viewpoint 1, which is unencrypted, is read out to the RAM 300d from the distributed media 400, and in Step S205 said image is displayed as an ordinary 2D image.

By the advanced processing above only the users who have concluded a contract with a stereoscopic image provider can view the 3D stereoscopic image data stored in the distributed media 400 as a 3D stereoscopic image. On the other hand, the users who haven't concluded a contract are given an opportunity to view the image data which corresponds to the viewpoint 1 only as an ordinary 2D image, which facilitates the users' desire to reproduce the image data as a 3D stereoscopic image. By this, while protecting the interests of the stereoscopic image providers, it is possible to promote expansion of the stereoscopic image distribution business.

8. Advanced Processing Flow 2

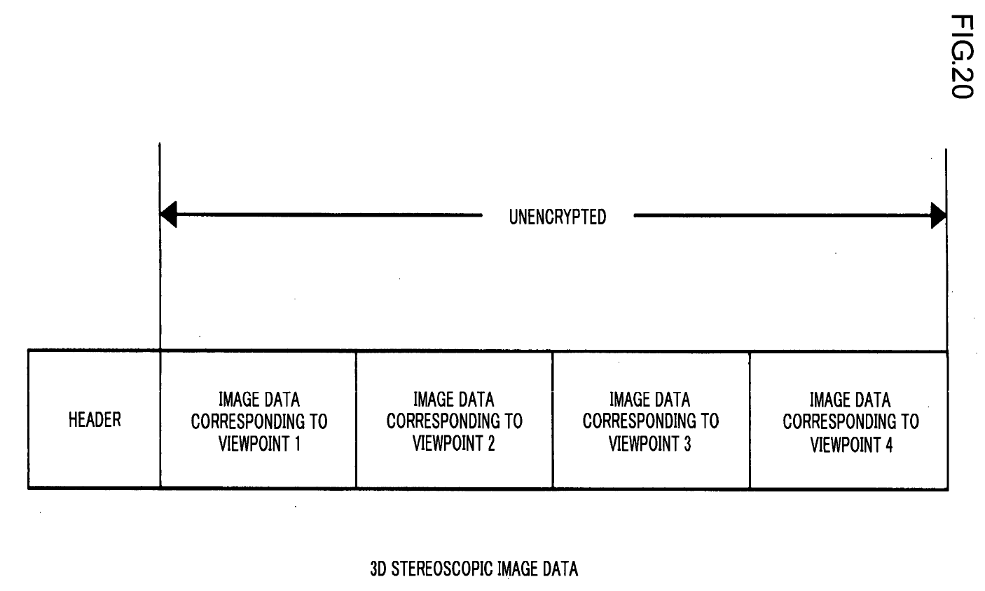

FIG. 20 shows another structure example of 3D stereoscopic image data stored in the distributed media 400. In this data structure example, a case is assumed in which none of the four image data, which correspond respectively to the viewpoints 1 through 4, are encrypted.

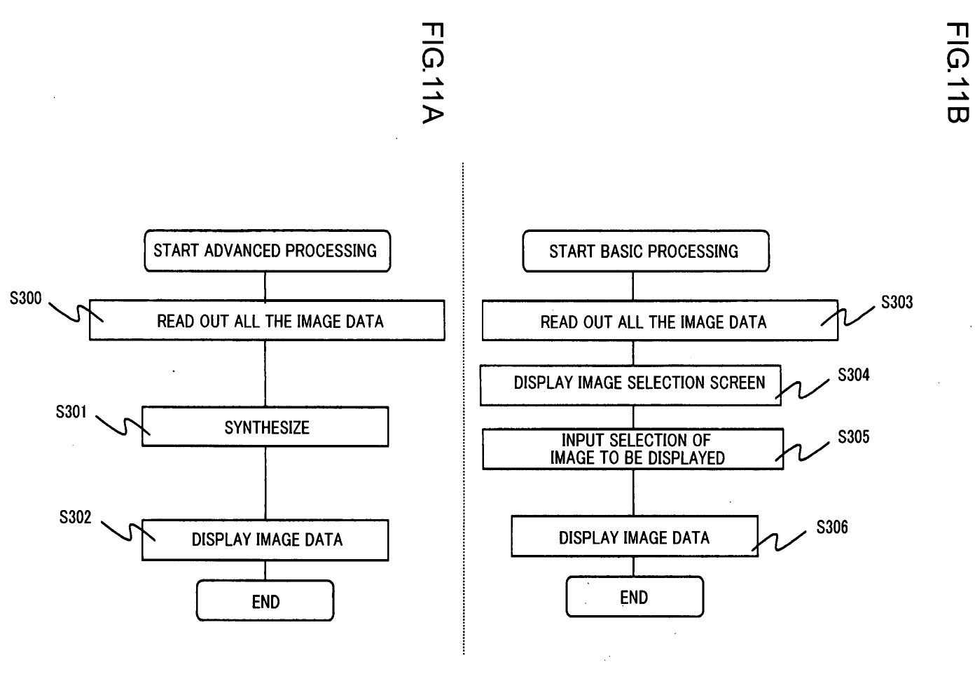

With reference to FIG. 11A, when the CPU 300c does an advanced processing, in Step S300 the four image data, which correspond respectively to the viewpoints 1 through 4, are read out to the RAM 300d from the distributed media 400. In Step S301 the four image data, which correspond respectively to the viewpoints 1 through 4, are synthesized to generate one 3D stereoscopic image data. In other words, by synthesizing the four image data, which correspond respectively to the four viewpoints, into one image data, a 3D stereoscopic image data which combines all the aspects of the four viewpoints is generated.

In Step S302 the generated 3D stereoscopic image data is displayed as a 3D stereoscopic image on the display apparatus 300a.

With reference to FIG. 11B, when the CPU 300c does a basic processing, in Step S303 the four image data, which correspond respectively to the viewpoints 1 through 4, are read out to the RAM 300d.

In Step S304 the CPU 300c displays a screen on the display apparatus 300a to ask the user to select one of the four image data, which correspond respectively to the viewpoints 1 through 4.

In Step S305 the user selects one of the four image data, which correspond respectively to the viewpoints 1 through 4, and then in Step S306 the CPU 300c displays the selected image data on the display apparatus 300a as an ordinary 2D image.

By the advanced processing above only the users who have concluded a contract with a stereoscopic image provider can view the 3D stereoscopic image data stored in the distributed media 400 as a 3D stereoscopic image. On the other hand, by selecting one of the four image data, which correspond respectively to the different viewpoints, the users who haven't concluded a contract are given an opportunity to view the selected image data as an ordinary 2D image, which facilitates the users' desire to reproduce the image data as a 3D stereoscopic image. By this, while protecting the interests of the stereoscopic image providers, it is possible to promote expansion of the stereoscopic image distribution business.

9. Advanced Processing Flow 3

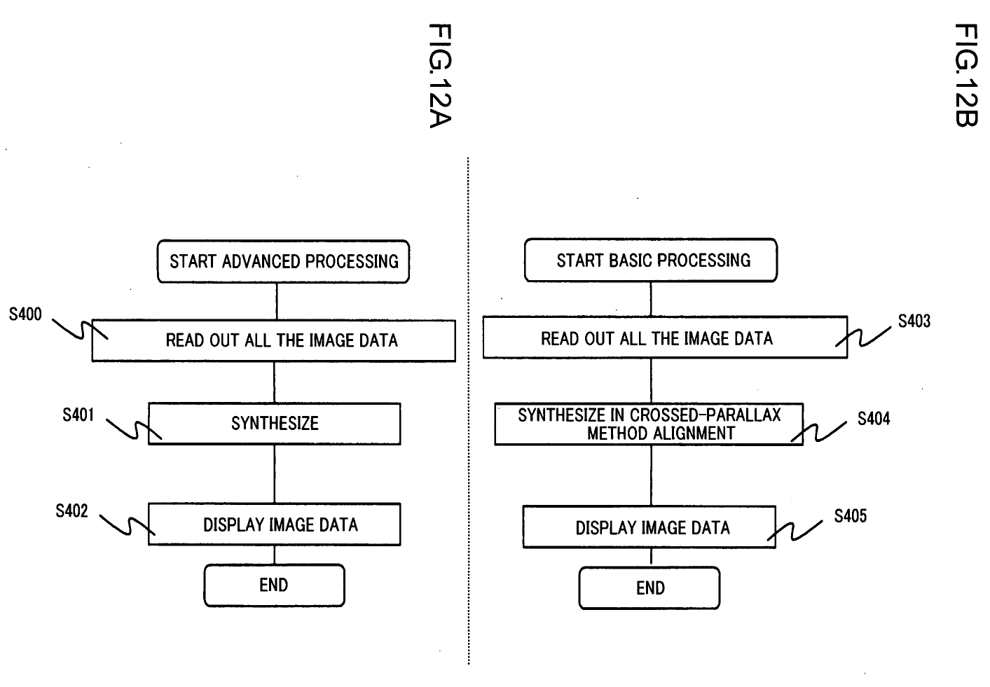

FIGS. 12A and 12B show flowcharts of an advanced processing and a basic processing which are done when the CPU 300c stores 3D stereoscopic image data with the aforementioned structure as shown in FIG. 20 in the distributed media 400.

With reference to FIG. 12A, when the CPU 300c does an advanced processing, in Step S400 the four image data, which correspond respectively to the viewpoints 1 through 4, are read out to the RAM 300d from the distributed media 400. In Step S401 the four image data, which correspond respectively to the viewpoints 1 through 4, are synthesized to generate one piece of 3D stereoscopic image data. In other words, the four image data, which correspond respectively to the four viewpoints, are synthesized into one piece of image data to generate a 3D stereoscopic image data which combines all the aspects of the four viewpoints.

In Step S402 the generated 3D stereoscopic image data is displayed on the display apparatus 300a as a 3D stereoscopic image.

With reference to FIG. 12B, when the CPU 300c does a basic processing, in Step S403 the four image data, which correspond respectively to the viewpoints 1 through 4, are read out to the RAM 300d from the distributed media 400.

In Step S404 the CPU 300c selects two of the four image data, which correspond respectively to the viewpoints 1 through 4, for example, the image data which corresponds to the viewpoint 2 and the image data which corresponds to the viewpoint 3, to synthesize them in a Crossed-Parallax method alignment. Synthesizing data in a Crossed-Parallax method alignment means synthesizing data so that a user can stereoscopically view the image only when looking at it cross-eyed.

In Step S405 the 3D stereoscopic image data, which has been synthesized by the Crossed-Parallax method, is displayed on the display apparatus 300a.

By the advanced processing above, only the users who have concluded a contract with a stereoscopic image provider can view the 3D stereoscopic image data stored in the distributed media 400 as a 3D stereoscopic image. On the other hand, the users who haven't concluded a contract are given an opportunity to view a 3D stereoscopic image by looking at it cross-eyed, which facilitates the users' desire to reproduce the image data as an ordinary 3D stereoscopic image. By this, while protecting the interests of the stereoscopic image providers, it is possible to promote expansion of the stereoscopic image distribution business.

10. Advanced Processing flow 4

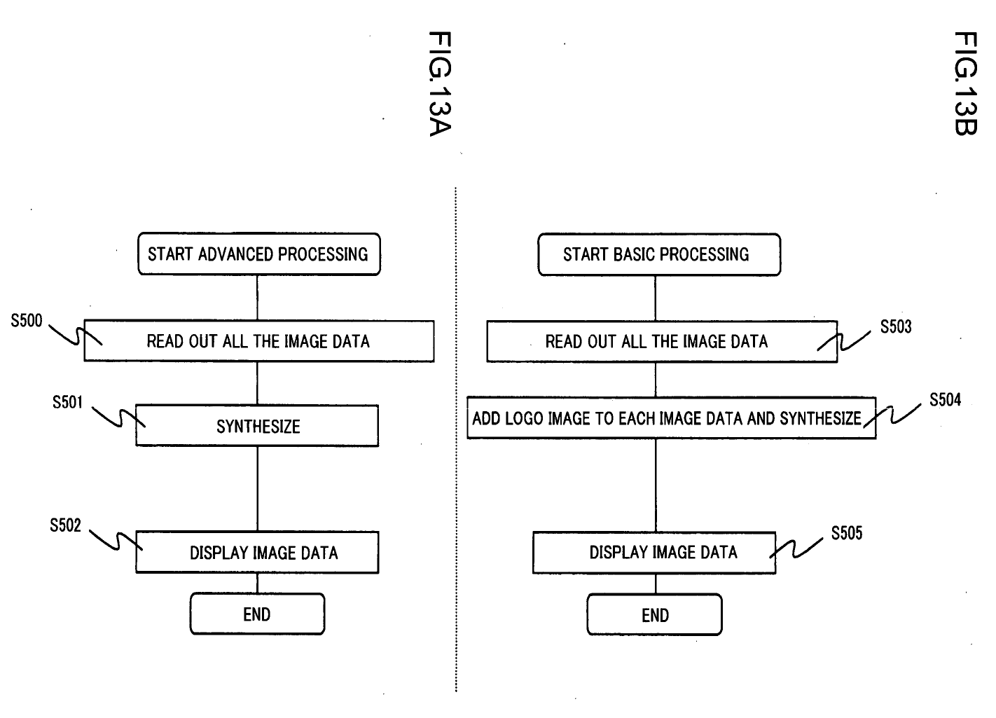

FIGS. 13A and 13B show flowcharts of an advanced processing and a basic processing which are done when the CPU 300c stores 3D stereoscopic image data with the aforementioned structure as shown in FIG. 20 in the distributed media 400.

With reference to FIG. 13A, when the CPU 300c does an advanced processing, in Step S500 the four image data, which correspond respectively to the viewpoints 1 through 4, are read out to the RAM 300d from the distributed media 400. In Step S501 the four image data, which correspond respectively to the viewpoints 1 through 4, are synthesized to generate one piece of 3D stereoscopic image data. In other words, the four image data, which correspond respectively to the four viewpoints, are synthesized into one piece of image data to generate a 3D stereoscopic image data which combines all the aspects of the four viewpoints.

In Step S502 the generated 3D stereoscopic image data is displayed on the display apparatus 300a as a 3D stereoscopic image.

With reference to FIG. 13B, when the CPU 300c does a basic processing, in Step S503 the four image data, which correspond respectively to the viewpoints 1 through 4, are read out to the RAM 300d from the distributed media 400.

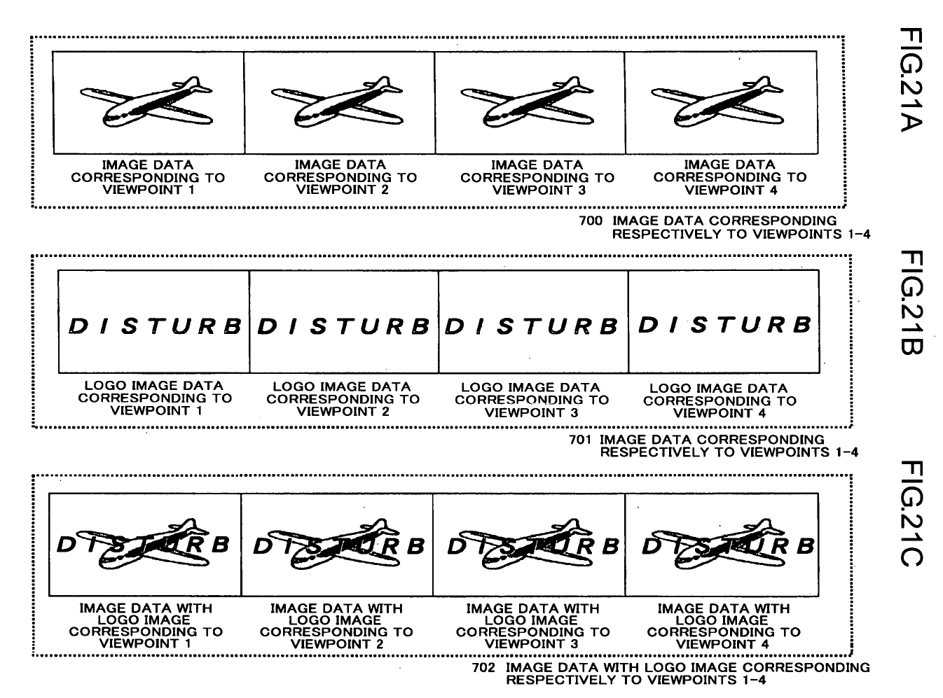

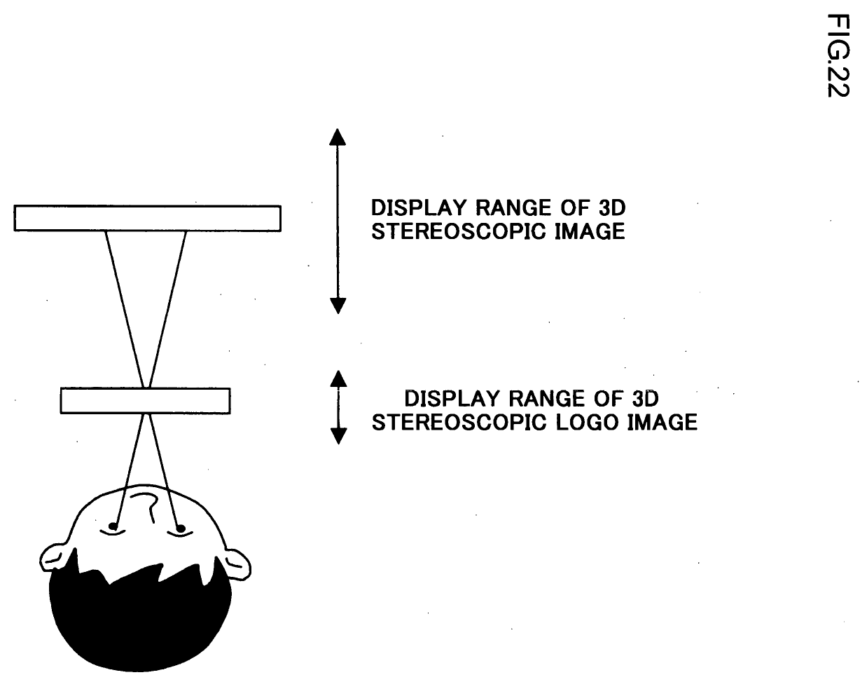

In Step S504 a logo image data is added to each of the four image data, which correspond respectively to the viewpoints 1 through 4. Then they are synthesized to generate one piece of 3D stereoscopic image data. Adding a logo image data to each of the four image data, which correspond respectively to the viewpoints 1 through 4, results in newly generating the four image data 702, which correspond respectively to the viewpoints 1 through 4 as shown in FIG. 21C, by adding the logo image 701 as shown in FIG. 21B to each of the four image data 700, which correspond respectively to the viewpoints 1 through 4 as shown in FIG. 21A. By synthesizing the four new image data 702, which correspond respectively to the viewpoints 1 through 4, as shown in FIG. 22 a 3D stereoscopic image data is generated in which a 3D logo image appears in front of the range where the original 3D stereoscopic image can be observed.

In Step S505 the 3D stereoscopic image data, which includes the generated 3D logo image data, is displayed on the display apparatus 300a as a 3D stereoscopic image.

By the advanced processing above only the users who have concluded a contract with a stereoscopic image provider can view the 3D stereoscopic image data stored in the distributed media 400 as a 3D stereoscopic image. On the other hand, the users who haven't concluded a contract are given an opportunity to view a 3D stereoscopic image with a logo at the front, which facilitates the users' desire to reproduce the image data as an ordinary 3D stereoscopic image without a logo. By this, while protecting the interests of the stereoscopic image providers, it is possible to promote expansion of the stereoscopic image distribution business.

11. Advanced Processing Flow 5

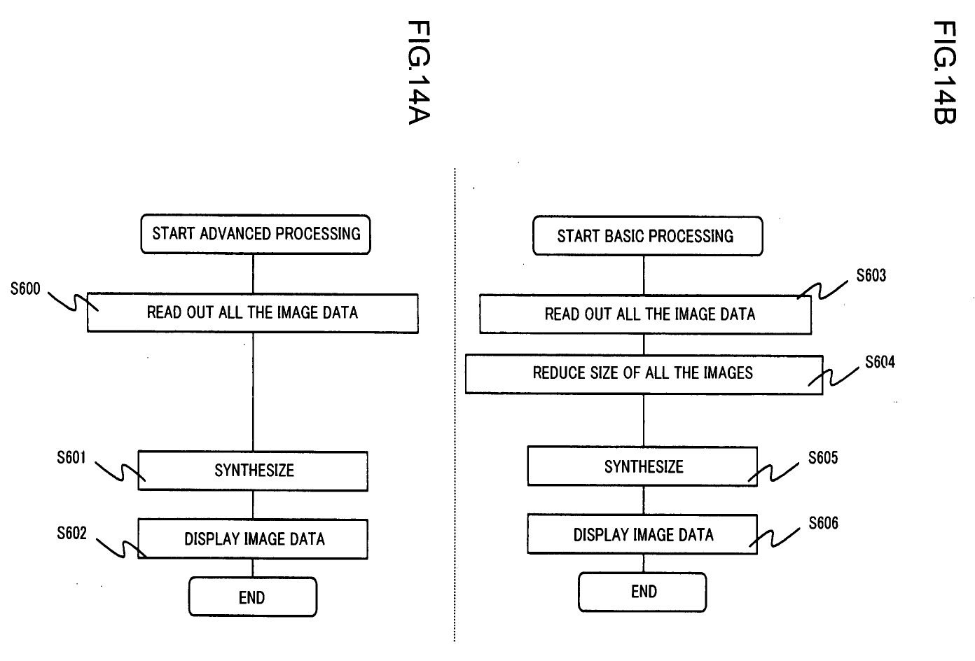

FIGS. 14A and 14B show flowcharts of an advanced processing and a basic processing which are done when the CPU 300c stores a 3D stereoscopic image data with the aforementioned structure as shown in FIG. 20 in the distributed media 400.

With reference to FIG. 14A, when the CPU 300c does an advanced processing, in Step S600 the four image data, which correspond respectively to the viewpoints 1 through 4, are read out to the RAM 300d from the distributed media 400. In Step S601 the four image data, which correspond respectively to the viewpoints 1 through 4, are synthesized to generate one piece of 3D stereoscopic image data. In other words, the four image data, which correspond respectively to the four viewpoints, are synthesized into one piece of image data to generate a 3D stereoscopic image data which combines all the aspects of the four viewpoints.

In Step S602 the generated 3D stereoscopic image data is displayed on the display apparatus 300a as a 3D stereoscopic image.

With reference to FIG. 14B, when the CPU 300c does a basic processing, in Step S603 the four image data, which correspond respectively to the viewpoints 1 through 4, are read out to the RAM 300d from the distributed media 400.

In Step S604 the CPU 300c reduces the size of the four image data which correspond respectively to the viewpoints 1 through 4.

In Step S605 the four reduced-size image data, which correspond respectively to the viewpoints 1 through 4, are synthesized to generate a reduced-size 3D stereoscopic image data.

In Step S606 the reduced-size 3D stereoscopic image data is displayed on the display apparatus 300a as a 3D stereoscopic image.

By the advanced processing above only the users who have concluded a contract with a stereoscopic image provider can view the 3D stereoscopic image data stored in the distributed media 400 as a 3D stereoscopic image. On the other hand, the users who haven't concluded a contract are given an opportunity to view a reduced-size 3D stereoscopic image, which facilitates the users' desire to reproduce the image data as a full-size 3D stereoscopic image. By this, while protecting the interests of the stereoscopic image providers, it is possible to promote expansion of the stereoscopic image distribution business.

12. Advanced Processing 6

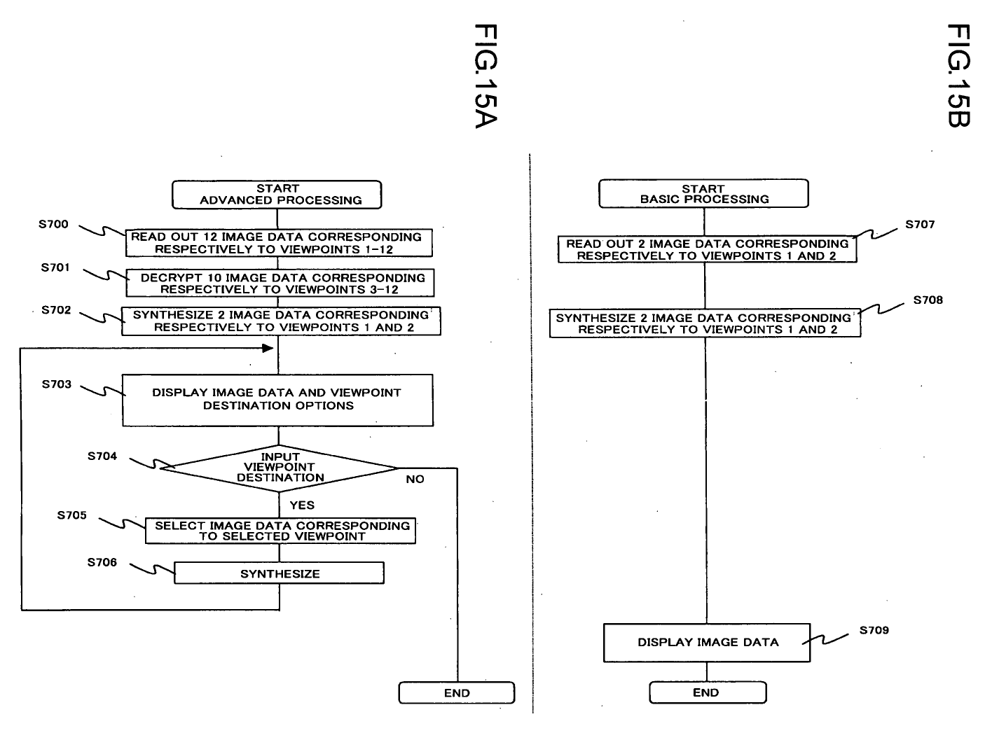

FIGS. 15A and 15B show flowcharts of an advanced processing and a basic processing which are done by the CPU 300c when multiple image data, which correspond respectively to the viewpoints located around the entire circumference of an object, are stored as 3D stereoscopic image data in the distributed media 400.

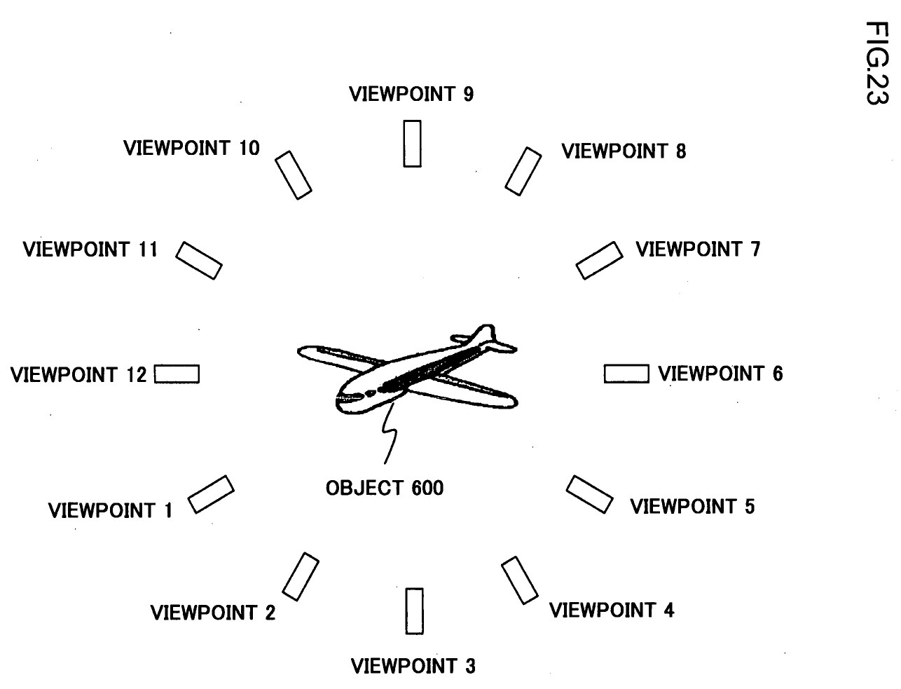

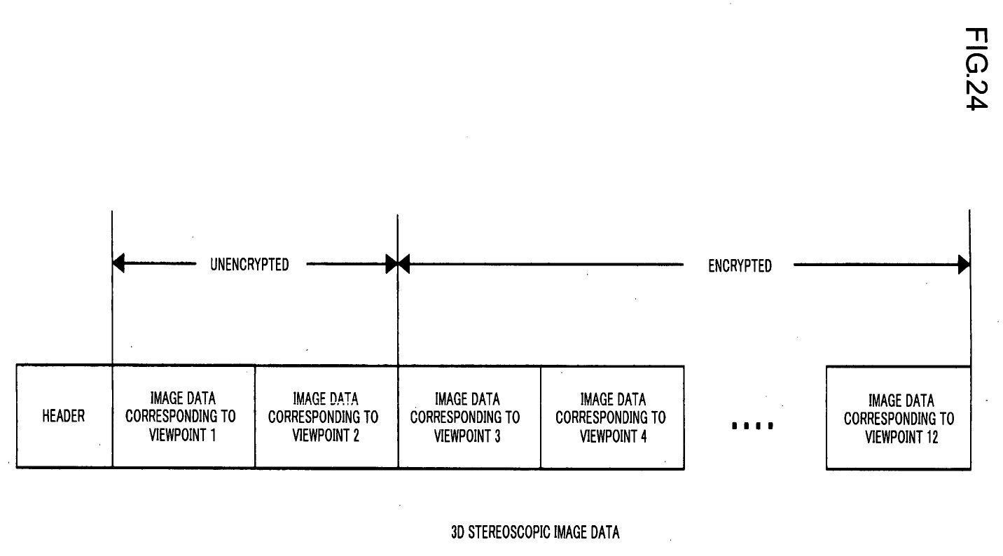

With reference to FIG. 23, the multiple image data, which correspond respectively to the viewpoints located around the entire circumference of the object, are the twelve image data, which correspond respectively to the viewpoints 1 through 12, surrounding the object 600. FIG. 24 shows the structure of a 3D stereoscopic image data, including the twelve image data which correspond respectively to said viewpoints 1 through 12. In FIG. 24 the two image data, which correspond respectively to the viewpoints 1 and 2, are unencrypted, and the ten image data, which correspond respectively to the viewpoints 3 through 12, are encrypted by a cryptographic key.

With reference to FIG. 15A, when the CPU 300c does an advanced processing, in Step S700 the twelve data, which correspond respectively to the viewpoints 1 through 12, are read out to the RAM 300d from the distributed media 400. In Step S701 the ten image data, which correspond respectively to the viewpoints 3 through 12, are decrypted by a cryptographic key.

Next, in Step S702 the two image data, which correspond respectively to the viewpoints 1 and 2, are synthesized to generate one piece of 3D stereoscopic image data. In other words, two image data, which correspond respectively to two viewpoints, are synthesized into one piece of image to generate a 3D stereoscopic image data which combines the aspects of the two viewpoints.

In Step S703 on the display apparatus 300a the generated 3D stereoscopic image data is displayed as a 3D stereoscopic image, and at the same time the viewpoint destination options which can be selected are displayed. In other words, the user can select one of the viewpoints 1 through 12.

In Step S704 if the user selects a viewpoint destination and the process proceeds to Step S705. However, if “End” is selected instead of a viewpoint destination the advanced processing ends.

In Step S705 the CPU 300c selects the image which corresponds to the selected viewpoint and the image which corresponds to the viewpoint adjacent to said viewpoint.

In Step S706 the two selected images are synthesized to generate one piece of 3D stereoscopic image data, and the process goes back to Step S703.

With reference to FIG. 15B, when the CPU 300c does a basic processing, in Step S707 the two image data, which correspond respectively to the viewpoints 1 and 2, are read out to the RAM 300d from the distributed media 400.

In Step S708 the two image data, which correspond respectively to the viewpoints 1 and 2, are synthesized to generate one piece of 3D stereoscopic image data.

In Step S709 the generated 3D stereoscopic image data is displayed on the display apparatus 300a as a 3D stereoscopic image.

By the advanced processing above only the users who have concluded a contract with a stereoscopic image provider can view the 3D stereoscopic image data stored in the distributed media 400 as a 3D stereoscopic image from the viewpoints around the entire circumference. On the other hand, the users who haven't concluded a contract are given an opportunity to view a 3D stereoscopic image from the viewpoints 1 and 2, which facilitates the users' desire to reproduce the image data as a 3D stereoscopic image viewable from the viewpoints around the entire circumference. By this, while protecting the interests of the stereoscopic image providers, it is possible to promote expansion of the stereoscopic image distribution business.

13. Advanced Processing 7

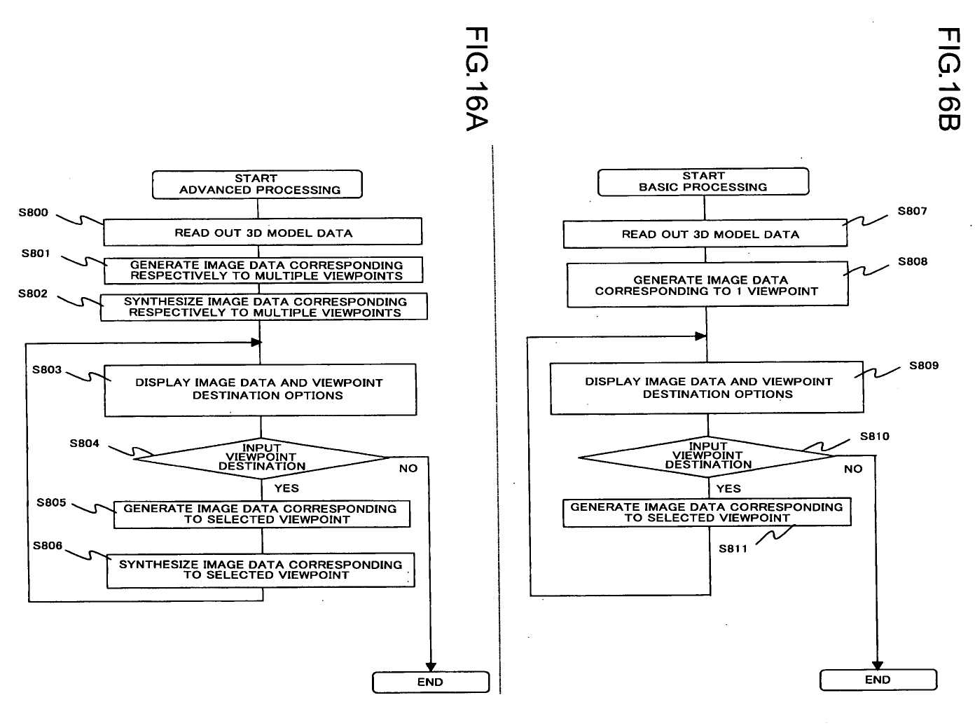

FIGS. 16A and 16B show flowcharts of an advanced processing and a basic processing which are done by the CPU 300c when 3D model data of an object or person to be displayed as a 3D stereoscopic image are stored in the distributed media 400.

3D model data is the basic data necessary to generate a 3D stereoscopic image data of an object or person viewable from viewpoints in all directions consisting of 3D figure data configured of lines and surfaces. Therefore, by generating multiple image data which correspond respectively to the optional viewpoints from the 3D model data, and further synthesizing it with the generated multiple image data, which correspond respectively to the multiple viewpoints, the 3D software stored in the distributed media 400 generates a 3D stereoscopic image data which combines all the aspects of the multiple viewpoints.

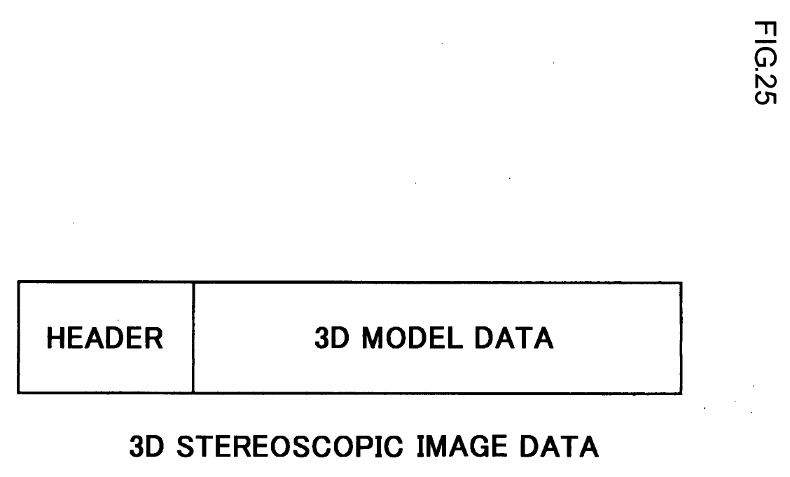

In this case, as shown in FIG. 25, the 3D stereoscopic image data stored in the distributed media 400 only includes the header and 3D model data.

With reference to FIG. 16A, when the CPU 300c does an advanced processing, in Step S800 the 3D model data is read out to the RAM 300d from the distributed media 400. Then, in Step S801 the multiple image data, which correspond respectively to the specified multiple viewpoints, are generated.

Next, in Step S802 the generated multiple image data which correspond respectively to the multiple viewpoints are synthesized to generate one piece of 3D stereoscopic image data.

In Step S803, on the display apparatus 300a the generated 3D stereoscopic image data is displayed as a 3D stereoscopic image, and at the same time the viewpoint destination options which can be selected are displayed. In other words, the user can select one optional viewpoint.

In Step S804 if the user selects a viewpoint destination the process proceeds to Step S805. However, if “End” is selected instead of a viewpoint destination the advanced processing ends.

In Step S805 the CPU 300c generates multiple image data, each of which corresponds to a selected viewpoint.

In Step S806 the generated multiple image data are synthesized to generate one piece of 3D stereoscopic image data, and the process goes back to Step S803.

With reference to FIG. 16B, when the CPU 300c does a basic processing, in Step S807 the 3D model data is read out to the RAM 300d. Then, in Step S808 a 2D image data which corresponds to a predetermined viewpoint is generated, and the process proceeds to Step S809.

In Step S809, on the display apparatus 300a the generated 2D image data is displayed as a 2D image, and at the same time the viewpoint destination options which can be selected are displayed. In other words, the user can select one optional viewpoint.

In Step S810 if the user selects a viewpoint destination the process proceeds to Step S811. However, if “End” is selected instead of a viewpoint destination the advanced processing ends.

In Step S811 the CPU 300c generates a 2D image data, which corresponds to the selected viewpoint, and the process goes back to Step S809.

By the advanced processing above only the users who have concluded a contract with a stereoscopic image provider can view the 3D model data stored in the distributed media 400 as a 3D stereoscopic image from an optional viewpoint. On the other hand, the users who haven't concluded a contract are given an opportunity to view a 3D model data as a 2D image from an optional viewpoint, which facilitates the users' desire to reproduce the image data as a 3D stereoscopic image from the optional viewpoint. By this, while protecting the interests of the stereoscopic image providers, it is possible to promote expansion of the stereoscopic image distribution business.

14. Advanced processing 8

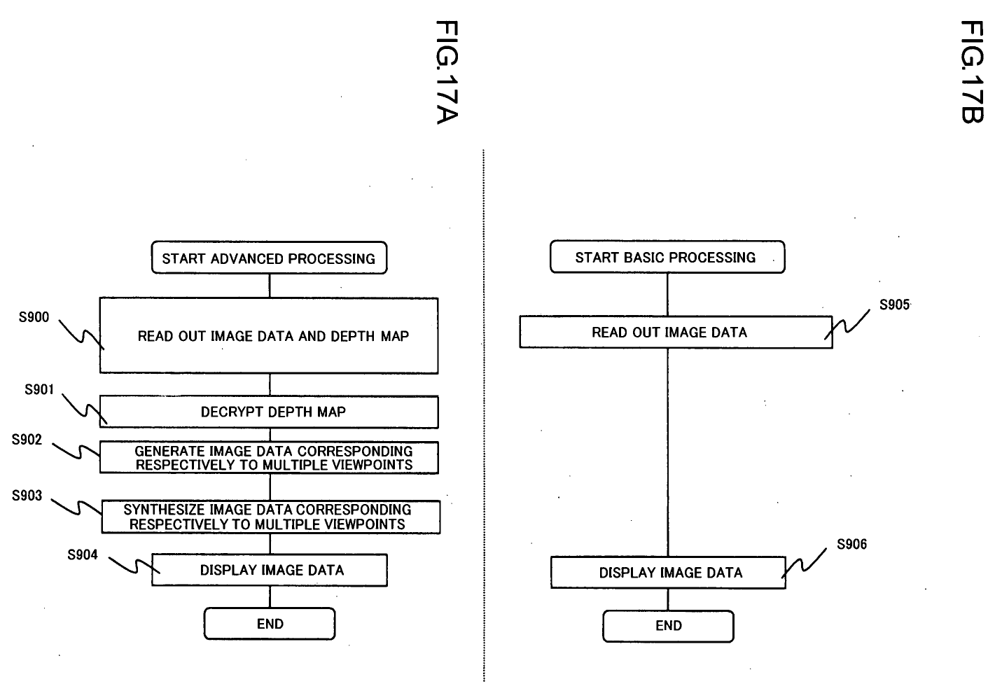

FIGS. 17A and 17B show flowcharts of an advanced processing and a basic processing which are done by the CPU 300c when an image data of an object or person to be displayed as a 3D stereoscopic image, which corresponds to a predetermined viewpoint, and a depth map are stored in the distributed media 400.

A depth map is depth data for each pixel of a 2D image, and indicates how much each pixel should be upraised or set back. By shifting a 2D image by pixel according to this data, an image which combines the aspects of other viewpoints (for example, an image which combines all the aspects of the viewpoints as shown in FIG. 18) is generated. A pixel with a higher absolute value of depth is shifted more and the parallax error is greater. As a result the degree of upraising or setting back becomes higher. However, since there is only the data for a 2D image, the originally unviewable parts, which appear by shifting the image, need to be created by guessing.

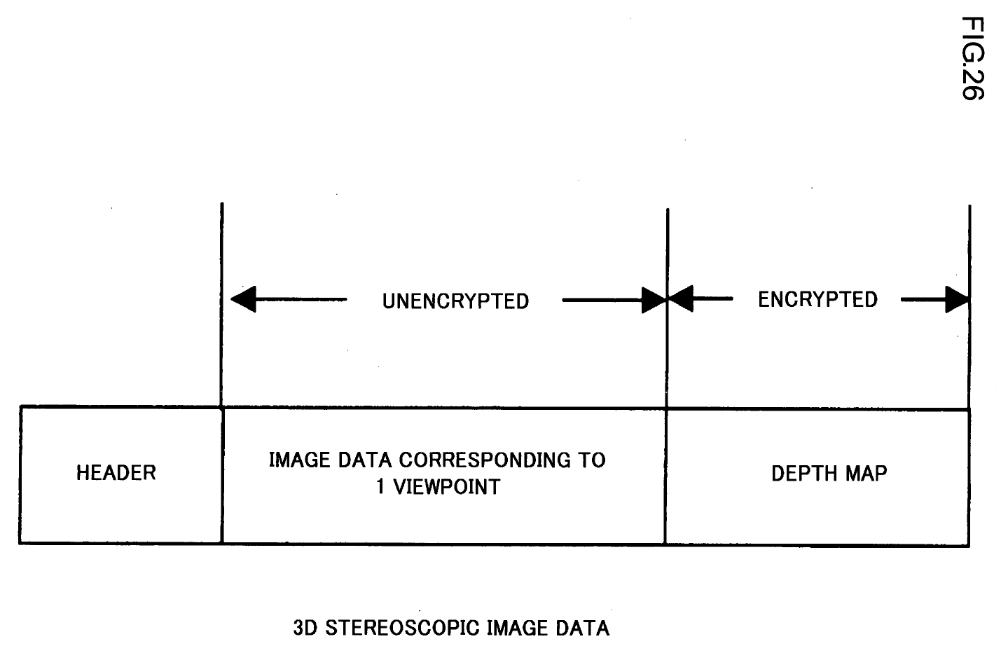

As shown in FIG. 26, the 3D stereoscopic image data stored in the distributed media 400 in this case is configured of the image data of the object or person to be displayed as a 3D stereoscopic image, which corresponds to one predetermined viewpoint, and a depth map. In FIG. 17 a case is assumed in which a depth map is encrypted by a cryptographic key.

With reference to FIG. 17A, when the CPU 300c does an advanced processing, in Step S900 the image data and depth map are read out to the RAM 300d from the distributed media 400. Then, in Step S901 the depth map is decrypted by a cryptographic key.

In Step S902 the multiple image data, which correspond respectively to the multiple viewpoints, are generated from the image data and decrypted depth map.

In Step S903 the generated multiple image data, which correspond respectively to the multiple viewpoints, are synthesized to generate one piece of 3D stereoscopic image data.

In Step S904 the generated 3D stereoscopic image data is displayed on the display apparatus 300a as a 3D stereoscopic image.

With reference to FIG. 17B, when the CPU 300c does a basic processing, in Step S905 only the image data is read out to the RAM 300d. Then, in Step S906 the image data is displayed on the display apparatus 300a as a 2D image.

By the advanced processing above only the users who have concluded a contract with a stereoscopic image provider can view the image data stored in the distributed media 400 as a 3D stereoscopic image from multiple viewpoints. On the other hand, the users who haven't concluded a contract are given an opportunity to view a 2D image from one viewpoint only, which facilitates the users' desire to reproduce the image data as a 3D stereoscopic image. By this, while protecting the interests of the stereoscopic image providers, it is possible to promote expansion of the stereoscopic image distribution business.

Further, in the embodiment described above, the 3D filter 500 connected to the user terminal 300 via USB is controlled by the CPU 300c according to the execution of the 3D software, regardless of the 3D software's processing type, advanced or basic, as follows: 1. When the image data is displayed as a 3D stereoscopic image, it is switched to “ON” and a barrier with multiple slits is formed by liquid crystal, and 2. When the image data is displayed as a 2D image, it is switched to “OFF” and the barrier with multiple slits is deactivated, so in this case the 3D filter 500 becomes a mere transparent filter.

However, since the 3D filter necessary to view a 4-viewpoint 3D stereoscopic image display and the 3D filter necessary to view a 2-viewpoint 3D stereoscopic image display differ from each other in the number of slits formed, distance between slits, etc., they can't be switched by an ON/OFF switch. Therefore, to view a 4-viewpoint 3D stereoscopic image display, a 3D filter for 4 viewpoints needs to be used, and to view a 2-viewpoint 3D stereoscopic image display, a 3D filter for 2 viewpoints needs to be used.

Although the present invention has been described by way of exemplary embodiments, it should be understood that many changes and substitutions may be made by those skilled in the art without departing from the scope of the present invention which is defined by the appended claims. Some such alterations are stated as follows.

For example, in the embodiment described above, an embodiment in which the disk ID and Encrypted Disk ID are stored in the distributed media 400 is shown, however it is also possible to store the filter ID and said filter ID encrypted by a cryptographic key (hereinafter referred to as “Encrypted Filter ID”) in the 3D filter 800, which is distributed together with the distributed media 400, instead of being stored in the distributed media 400.

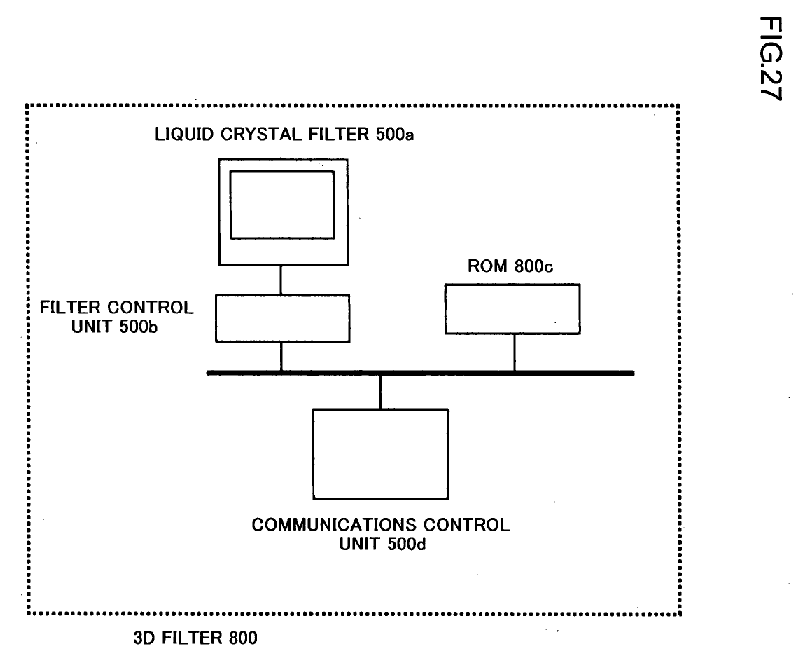

In this case, as shown in FIG. 27, the 3D filter 800 is equipped with the ROM 800c which stores said filter ID and the Encrypted Filter ID, and by the communications control unit 500d the filter ID and Encrypted Filter ID are sent to the user terminal 300 for example via USB.

In the user terminal 300, in Step S102 as shown in FIG. 7 and Step S119 as shown in FIG. 9, the CPU 300c decrypts the Encrypted Filter ID received from the 3D filter 800 by using the cryptographic key, and checks to see whether or not it matches with the filter ID also received from the 3D filter. Further, in Step S106 as shown in FIG. 8, the CPU 300c reads out the Encrypted Filter ID from the 3D filter 800 instead of the Encrypted Disk ID, and sends it to the service providing device 100 from the communications control unit 300b.

In this case, with reference to FIG. 5, the ID database 100b of the service providing device 100 stores the following which correspond to the Encrypted Filter ID within the 3D filter 800 instead of the Encrypted Disk ID within the distributed media 400 which has been distributed to the user: distribution flag, a cryptographic key, and data regarding whether or not catalog distribution is requested etc. As described above, the cryptographic key is necessary to display a 3D stereoscopic image data, which is included in the distributed media 400, by the 3D software, and by decrypting the Encrypted Filter ID within the 3D filter 800 by this cryptographic key the filter ID can be obtained.

In the service providing device 100, in Step S108 the Encrypted Filter ID sent from the user terminal 300 is received, and in Step S109 the CPU 100c searches for the Encrypted Filter ID which has been received on the ID database 100b. In the subsequent steps from Step S110 to Step S114, processing in each step is done based on the Encrypted Filter ID instead of the Encrypted Disk ID.

Thus, when the 3D filter 800 is equipped with an ID, the users can't view a 3D stereoscopic image in the distributed media without having the 3D filter 800, which enables prevention of illegal usage by copying of the distributed media 400 etc.

Further, it is possible to do processing by storing one of either the ID or Encrypted ID in the distributed media 400, and storing the other in the 3D filter 800.

For example, when storing the Encrypted Disk ID in the distributed media 400 and storing the filter ID in the 3D filter 800, in Step S102 as shown in FIG. 7 and Step S119, in the user terminal 300 the CPU 300c decrypts the Encrypted Filter ID obtained from the distributed media 400 by using a cryptographic key, and checks to see whether or not the decrypted filter ID matches with the filter ID received from the 3D filter 800.

On the other hand, when storing the filter ID in the distributed media 400 and storing the Encrypted Filter ID in the 3D filter 800, in Step 102 as shown in FIG. 7 and Step S119 as shown in FIG. 9, in the user terminal 300 the CPU 300c decrypts the Encrypted Filter ID received from the 3D filter 800 by using a cryptographic key, and checks to see whether or not the decrypted filter ID matches with the filter ID obtained from the distributed media 400. Further, in Step S106 as shown in FIG. 8, the CPU 300c reads out the Encrypted Filter ID from the 3D filter 800 instead of the Encrypted Disk ID, and sends it to the service providing device 100 from the communications control unit 300b.

In this case, with reference to FIG. 5, the ID database 100b of the service providing device 100 stores the following which correspond to the Encrypted Filter ID within the 3D filter 800 instead of the Encrypted Disk ID within the distributed media 400 which has been distributed to the user: a cryptographic key, distribution flag, and data regarding whether or not catalog distribution is requested etc. As described above, the cryptographic key is necessary to display a 3D stereoscopic image data, which is included in the distributed media 400 by the 3D software, and by decrypting the Encrypted Filter ID within the 3D filter 800 by this cryptographic key the filter ID can be obtained.

In the service providing device 100, in Step S108 the Encrypted Filter ID sent from the user terminal 300 is received, and in Step S109, the CPU 100c searches for the Encrypted Filter ID which has been received on the ID database 100b.

In the subsequent steps from Step S110 to Step S114, processing in each step is done based on the Encrypted Filter ID instead of the Encrypted Disk ID.

Furthermore, in the embodiment described above, a case is stated, in which the data which configures the 3D stereoscopic image data stored in the distributed media 400 is encrypted by a cryptographic key. However, it is possible to encrypt by a cryptographic key a part of the program stored in the distributed media 400 which is necessary to implement an advanced processing, for example, a library which is linked when executing an advanced processing, or a dynamic link library, instead of the 3D stereoscopic image data. In this case, with reference to FIGS. 7 and 9, if the cryptographic key is valid, then in Step S103 and Step S120, when the advanced processing flag was turned to ON the part of the program, which was encrypted, is decrypted by the cryptographic key.

In addition, it is possible to encrypt by the cryptographic key both a part of the advanced processing program and 3D stereoscopic image data.

Beside the above, the following variations are possible.

(1) In the advanced processing flow 6, it is set up so that for the basic processing a 3D stereoscopic image from a fixed viewpoint can be viewed, and for the advanced processing a 3D stereoscopic image from an optional viewpoint can be viewed. However, it can also be set up so that for the basic processing, a 2D image from an optional viewpoint can be viewed, and for the advanced processing a 3D stereoscopic image from an optional viewpoint can be viewed.

(2) It may be also set up so that the image data and 3D software can be obtained by some other means besides distribution by the distributed media 400, such as downloading from the Internet etc. If the filter ID is stored in the 3D filter 800, the disk ID is not necessary, and it is also possible to store the ID and Encrypted ID within respective 3D software.

(3) When the user demands downloading of image data or logs in, the user ID is sent from the user and whether or not a contract has been concluded is checked. For the users who have concluded a contract, 3D stereoscopic image data is distributed by an advanced processing, and for the users who have not concluded a contract, 2D image data is distributed by a basic processing. In this example, the processing in the service providing device 100 changes for basic processing or advanced processing.

(4) It may also be set up so that the viewable time is limited for the basic processing. While by the advanced processing a 3D stereoscopic image can be viewed freely, by the basic processing viewing of a 3D stereoscopic image is allowed for only a few minutes, and after the time limit only viewing of a 2D image is available.

(5) It may also be set up so that the viewable region is limited for the basic processing. While by the advanced processing an entire 3D stereoscopic image can be viewed, by the basic processing viewing of only a part of a 3D stereoscopic image is allowed.

(6) Since data analysis of a 3D stereoscopic image is difficult and 3D software cannot be made easily, it is possible to protect the interests of the providers even without encryption. Even for image data, if the data structure is complicated enough, encryption is not always necessary.

(7) An extension tag may be set up for image data and 3D model data. When the extension tag is 0 only a 2D image display is allowed, and when the extension tag is 1 a 3D stereoscopic image display is allowed. By this tag, the 3D software determines which processing, basic or advanced, will be done. For the users who have concluded a contract, data with the extension tag being 1 is distributed. Or, a process to change the already distributed data tag value from 0 to 1 may be set up in the processing step flow.

Thus, according to the present invention, while preventing the providing servers' interests from being hurt by unauthorized copying, it is possible to offer an image content reproduction system and its program, which enables proactive development of 3D stereoscopic image data distribution services.

What is claimed is:

1. A three-dimensional image displaying method comprising:
determining whether a three-dimensional stereoscopic image content can be reproduced as a three-dimensional stereoscopic image;
reproducing the content as a three-dimensional stereoscopic image when it is determined that the content can be reproduced as a three-dimensional stereoscopic image; and
switching to a process for reproducing the content with a restriction when it is determined that the content cannot be reproduced as a three-dimensional stereoscopic image.

2. The method of claim 1, wherein the process for reproducing the content with a restriction is a process for reproducing the content as a two-dimensional image.

3. The method of claim 1, wherein the process for reproducing the content with a restriction is a process for reproducing a part of the content as a three-dimensional stereoscopic image.

4. The method of claim 1, wherein the process for reproducing the content with a restriction is a process for reproducing the content on which another image is superimposed.

5. The method of claim 1, further comprising obtaining a key for reproducing the content as a three-dimensional stereoscopic image when it is determined that the content cannot be reproduced as a three-dimensional stereoscopic image.

6. The method of claim 5, wherein the content is encoded by the key, and further comprising decoding the content by using the key in reproducing the content.

7. The method of claim 5, wherein a program for reproducing the content as a three-dimensional stereoscopic image is encoded by the key, and further comprising decoding the program by using the key in reproducing the content as a three-dimensional stereoscopic image.

8. A program for providing a computer with a function for displaying a three-dimensional stereoscopic image comprising:
reproducing a three-dimensional stereoscopic image content as a three-dimensional stereoscopic image;
reproducing the content with a restriction;
determining whether the content can be reproduced as a three-dimensional stereoscopic image; and
switching a reproduction process according to a result of the determining.

9. The program of claim 8, wherein the reproducing the content with a restriction performs a process for reproducing the content as a two-dimensional image.

10. The program of claim 8, wherein the reproducing the content with a restriction performs a process for reproducing a part of the content as a three-dimensional stereoscopic image.

11. The program of claim 8, wherein the reproducing the content with a restriction performs a process for reproducing the content on which another image is superimposed.

12. The program of claim 8, further comprising obtaining a key for reproducing the content as a three-dimensional stereoscopic image by accessing a server which offers the content.

13. The program of claim 12, wherein the obtaining the key is performed when it is determined that the content cannot be reproduced as a three-dimensional stereoscopic image.

14. The program of claim 12, wherein the content is encoded by the key, and the reproducing the content as a three-dimensional stereoscopic image includes decoding the content by using the key.

15. The program of claim 12, wherein a program module for reproducing the content as a three-dimensional stereoscopic image is encoded by the key, and the switching the reproduction process includes decoding the program module by using the key.

16. The program of claim 12, further comprising an encoded identification code therein, and wherein it is determined whether the content can be reproduced as a three-dimensional stereoscopic image, by decoding the encoded identification code by using the key.

17. The program of claim 16, further comprising an unencoded identification code as well as the encoded identification code therein, and wherein it is determined whether the content can be reproduced as a three-dimensional stereoscopic image, by decoding the encoded identification code by using the key and comparing the decoded identification code with the unencoded identification code.

18. The program of claim 12, further comprising obtaining an encoded identification code from a three-dimensional stereoscopic image filter for viewing the content stereoscopically, and wherein it is determined whether the content can be reproduced as a three-dimensional stereoscopic image, by decoding the encoded identification code by using the key.

19. The program of claim 18, further comprising obtaining an unencoded identification code as well as the encoded identification code, and wherein it is determined whether the content can be reproduced as a three-dimensional stereoscopic image, by decoding the encoded identification code by using the key and comparing the decoded identification code with the unencoded identification code.

20. A storage medium storing a program for providing a computer with a function for displaying a three-dimensional stereoscopic image, the program comprising:
reproducing a three-dimensional stereoscopic image content as a three-dimensional stereoscopic image;
reproducing the content with a restriction;
determining whether the content can be reproduced as a three-dimensional stereoscopic image; and
switching a reproduction process according to a result of the determining.

21. The storage medium of claim 20, wherein the program further comprises obtaining a key for reproducing the content as a three-dimensional stereoscopic image by accessing a server which offers the content.

22. The storage medium of claim 21, further comprising an encoded identification code therein, and wherein it is determined whether the content can be reproduced as a three-dimensional stereoscopic image, by decoding the encoded identification code by using the key.

23. The storage medium of claim 22, further comprising an unencoded identification code as well as the encoded identification code therein, and wherein it is determined whether the content can be reproduced as a three-dimensional stereoscopic image, by decoding the encoded identification code by using the key and comparing the decoded identification code with the unencoded identification code.

24. The storage medium of claim 21, further comprising the content with the program therein, and wherein the content is encoded by the key, and the reproducing the content as a three-dimensional stereoscopic image includes decoding the content by using the key.

25. The storage medium of claim 21, wherein a part of the program is encoded by the key, and the switching the reproduction process includes decoding the part of the program by using the key.

26. A server comprising:
a storing unit which stores a key which corresponds to an identification code of a program, which is offered to a user, for providing a computer with a function for displaying a three-dimensional stereoscopic image;
a determining unit which determines whether an access from a user terminal is valid; and
a transmitting unit which transmits the key which corresponds to the program to the user terminal when the access is determined to be valid.

27. A three-dimensional stereoscopic image filter for viewing a content stereoscopically comprising:
a storing unit which stores an encoded identification code and an unencoded identification code; and
a transmitting unit which retrieves the encoded identification code and the unencoded identification code from the storing unit and transmits the identification codes to a user terminal.
